(19) United States
(12) Patent Application Publication
(10) Pub. No.: US 2013/0162076 A1
(43) Pub. Date: Jun. 27, 2013

(54) BASE ASSEMBLY

(71) Applicant: Samsung Electro-Mechanics Co., Ltd., Suwon (KR)

(72) Inventor: Tae Hyeong LIM, Suwon (KR)

(73) Assignee: SAMSUNG ELECTRO-MECHANICS CO., LTD., Suwon (KR)

(21) Appl. No.: 13/653,953

(22) Filed: Oct. 17, 2012

(30) Foreign Application Priority Data
Dec. 22, 2011 (KR) 10-2011-0139990

(51) Int. Cl. H02K 5/10

(52) U.S. Cl. 310/88

(57) ABSTRACT

There is provided a base assembly, including: a rotor including a rotor hub on which at least one disc is mounted; a stator rotatably supporting the rotor; and a base member having the stator fixedly mounted thereon and forming an internal space with the rotor hub, wherein at least one of the base member and an opposite surface of the rotor hub facing the base member has a cleaning solution penetration prevention part.

### CROSS-REFERENCE TO RELATED APPLICATIONS

This application claims the priority of Korean Patent Application No. 10-2011-0139990 filed on Dec. 22, 2011, in the Korean Intellectual Property Office, the disclosure of which is incorporated herein by reference.

### BACKGROUND OF THE INVENTION

1. Field of the Invention

The present invention relates to a base assembly.

2. Description of the Related Art

With the miniaturization and enlargement of the capacity of a recording disc driving apparatus, the recording disc driving apparatus has not only been mounted in a mobile type personal computer as a storage device, but has also been mounted in a portable music player or a video camera as a device for recording music, voice audio, and video.

The recording disc driving apparatus basically includes at least one disc rotatably driven at a high speed and a head in contact with or suspended above a surface of the disc to read information stored thereon.

Recently, an increasing number of discs have been mounted in a recording disc driving apparatus so as to meet demand for an increase in recording capacity. In addition, a gap between the disc and the head tends to be narrow.

Therefore, there is a need to manage smaller sized foreign objects. That is, the gap between the disc and the head is becoming ever narrower, and therefore, operational defects may be caused due to micro-sized foreign objects.

However, according to the related art, device parts are cleaned before a spindle motor (that is, a combined body between a stator and a rotor) is assembled with a base member and then, the parts are assembled in an closed environment such as a clean room, and foreign objects are removed therefrom by blowing high-pressure air into the parts before packing or are removed by cleaning the parts in a vacuum environment.

However, there is a limitation in removing micro-sized foreign objects by the related art method of removing foreign objects.

Therefore, a development of a base assembly structure allowing for the cleaning thereof by being dipped in a cleaning solution has been urgently required.

The recording disc driving apparatus including the base member is disclosed in Korean Patent Laid-Open Publication No. 10-2003-0080875.

### SUMMARY OF THE INVENTION

An aspect of the present invention provides a base assembly that can be easily cleaned by a cleaning solution.

According to aspect of the present invention, there is provided a base assembly, including: a rotor including a rotor hub on which at least one disc is mounted; a stator rotatably supporting the rotor; and a base member having the stator fixedly mounted thereon and forming an internal space with the rotor hub, wherein at least one of the base member and an opposite surface of the rotor hub facing the base member has a cleaning solution penetration prevention part.

The rotor hub may include a disc-shaped body, a magnet mounting part extending downwardly from the body in an axial direction, and a disc seating part extending from the magnet mounting part in a radial direction.

The base member may be provided with an insertion groove to thereby form an internal space with the rotor hub, and the cleaning solution penetration prevention part may be disposed in at least one of the disc seating part inserted into the insertion groove and an opposite surface of the base member facing the disc seating part.

The cleaning solution penetration prevention part may include a cleaning solution blocking agent applied to at least one of the disc seating part and the opposite surface of the base member facing the disc seating part.

The cleaning solution penetration prevention part may further include an indented groove formed in at least one of the disc seating part and the opposite surface of the base member facing the disc seating part, and the indented groove may be filled with the cleaning solution blocking agent.

The indented groove may be formed in at least one of an outer peripheral surface of the disc seating part and a side wall of the insertion groove facing the outer peripheral surface of the disc seating part.

The indented groove may be formed in at least one of a bottom surface of the disc seating part and a bottom surface of the insertion groove facing the bottom surface of the disc seating part.

The cleaning solution blocking agent may be formed by dissolving a fluorine-based resin in a fluorine-based solvent.

According to another aspect of the present invention, there is provided a base assembly, including: a rotor including a rotor hub on which at least one disc is mounted; a stator rotatably supporting the rotor; and a base member having the stator fixedly mounted thereon and forming an internal space with the rotor hub, wherein the base member and an opposite surface of the rotor hub facing the base member have a gap therebetween, the gap having a width of 0.3 mm or less.

The rotor hub may include a disc-shaped body, a magnet mounting part extending downwardly from the body in an axial direction, and a disc seating part extending from the magnet mounting part in a radial direction. An outer peripheral surface of the disc seating part and an opposite surface of the base member facing the outer peripheral surface of the disc seating part may have a gap therebetween, the gap having a width of 0.3 mm or less.

The base member may be provided with an insertion groove to thereby form an internal space with the rotor hub.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing abase assembly according to an embodiment of the present invention;

FIG. 2 is an enlarged view showing portion A of FIG. 1;

FIG. 3 is an enlarged view showing portion B of FIG. 2;

FIG. 4 is a view illustrating an operation of a base assembly according to an embodiment of the present invention;

FIG. 5 is a schematic cross-sectional view showing abase assembly according to another embodiment of the present invention;

FIG. 6 is an enlarged view showing portion C of FIG. 5; and

FIG. 7 is an enlarged view showing a portion corresponding to portion B of FIG. 3 of a base assembly according to another embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components therein, but those are to be construed as being included in the spirit of the present invention.

Further, when it is determined that a detailed description of the known art, related to the present invention, may obscure the gist of the present invention, a detailed description thereof will be omitted.

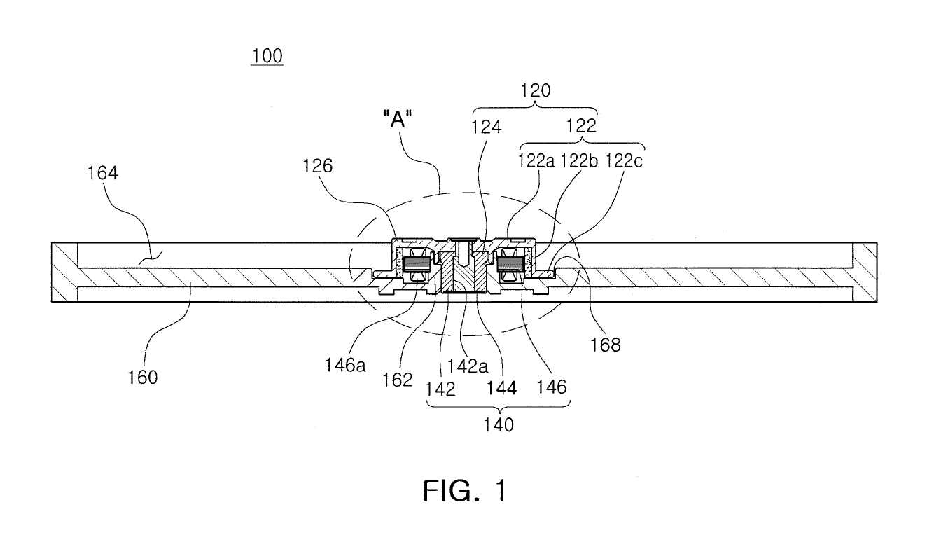

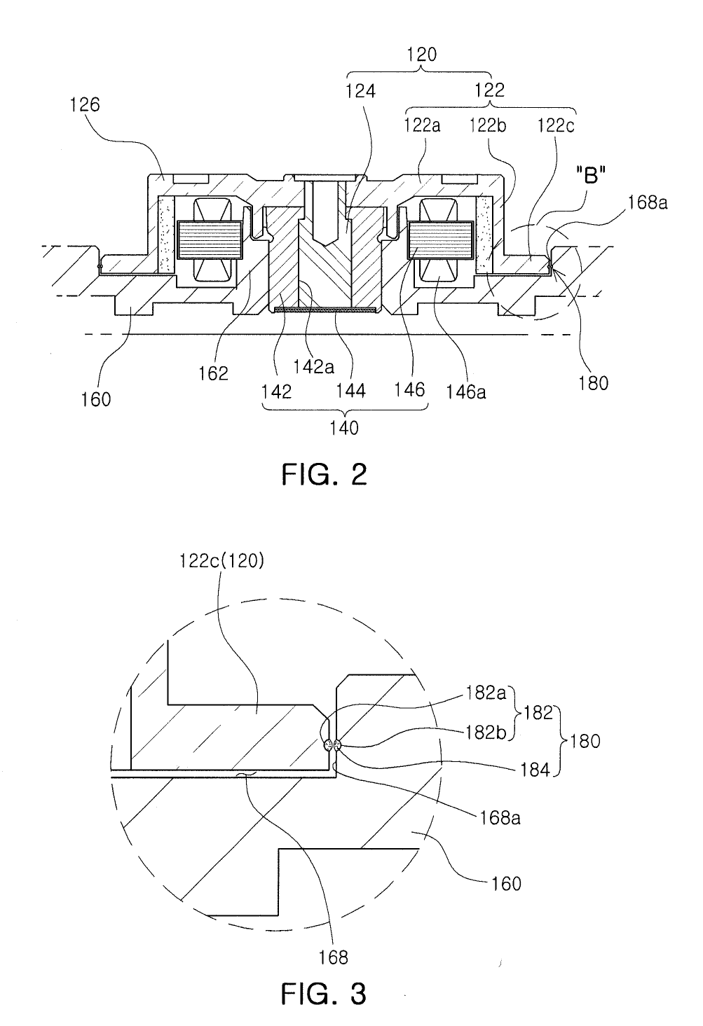

FIG. 1 is a schematic cross-sectional view showing a base assembly according to an embodiment of the present invention, FIG. 2 is an enlarged view showing portion A of FIG. 1, and FIG. 3 is an enlarged view showing portion B of FIG. 2.

Referring to FIGS. 1 through 3, a base assembly 100 according to an embodiment of the present invention may include, for example, a rotor 120, a stator 140, a base member 160, and a cleaning solution penetration prevention part 180.

Meanwhile, the base assembly 100 may be mounted in a recording disc driving apparatus that performs reading/writing on the recording disc.

The rotor 120 may include a rotor hub 122 on which at least one disc is mounted.

Meanwhile, the rotor 120 refers to a rotating member rotatably supported by the stator 140, and may include the rotor hub 122 and a shaft 124.

First, terms with regard to directions will be defined. As shown in FIG. 2, an axial direction refers to a vertical direction, that is, a direction from the top of the shaft 124 toward the bottom thereof or a direction from the bottom of the shaft 124 to the top thereof and a radial direction refers to a horizontal direction, that is, a direction from the shaft 124 toward an outer peripheral surface of the rotor hub 122 or a direction from the outer peripheral surface of the rotor hub 122 toward the shaft 124.

Meanwhile, a circumferential direction refers to a direction rotating along an outer peripheral surface of the shaft 124 or the outer peripheral surface of the rotor hub 122.

The rotor hub 122 may be fixedly mounted on a top end of the shaft 124 to rotate together with the shaft 124.

Further, the rotor hub 122 may include a disc-shaped body 122a fixedly mounted on the shaft 124, a magnet mounting part 122b extending downwardly from the body 122a in the axial direction, and a disc seating part 122c extending from the magnet mounting part 122b in the radial direction.

Meanwhile, a driving magnet 126 may be fixedly mounted on an inner surface of the magnet mounting part 122. The driving magnet 126 may have an annular ring shape and may be a permanent magnet generating magnetic force having a predetermined strength by alternately magnetizing N and S poles in the circumferential direction.

In addition, at least one disc (not shown) may be seated on the disc seating part 122c.

The shaft 124 may be rotatably supported by the stator 140. Further, the rotor hub 122 may be fixedly mounted on the top end of the shaft 124.

The stator 140 may rotatably support the rotor 120. That is, the stator 140 refers to a fixed member for rotatably supporting the rotor 120, and may include a sleeve 142, a cover member 144, and a stator core 146.

As shown in FIG. 2, the sleeve 142 is fixed to a mounting part 162 of the base member 160. That is, an outer peripheral surface of the sleeve 142 may be bonded to an inner peripheral surface of the mounting part 162 by press-fitting or using an adhesive.

Further, the sleeve 142 may have a hollow cylindrical shape. In other words, the sleeve 142 may have a cylindrical shape having a shaft hole 142a.

Meanwhile, when the shaft 124 is inserted into the shaft hole 142a of the sleeve 142, the inner peripheral surface of the sleeve 142 and the outer peripheral surface of the shaft 124 are disposed to be spaced apart from each other by a predetermined interval, to thereby form a bearing clearance therebetween. Further, this bearing clearance may be filled with a lubricating fluid.

The cover member 144 is fixedly mounted on a bottom end of the sleeve 142. Meanwhile, the cover member 144 serves to prevent the lubricating fluid filling the bearing clearance from being leaked downwardly of the sleeve 142.

The stator core 146 is fixed to the outer peripheral surface of the mounting part 162 and a coil 146a is wound around the stator core 146. Meanwhile, a front end of the stator core 146 is disposed to face the inner peripheral surface of the driving magnet 126.

Here, the rotational driving of the rotor hub 122 will be described. When power is supplied to the coil 146a wound around the stator core 146, driving force capable of rotating the rotor hub 122 is generated by electromagnetic interaction between the driving magnet 126 and the stator core 146 having the coil 146a wound therearound.

Therefore, the rotor hub 122 is rotated, such that the shaft 124 to which the rotor hub 122 is fixedly coupled may rotate together with the rotor hub 122.

The base member 160 is fixed to the stator 140 and the base member 160 and the rotor hub 122 form an internal space.

Further, the base member 160 may include a disc mounting part 164 having a disc (not shown) disposed thereon and an actuator mounting part (not shown) adjacent to the disc mounting part 164.

Further, the disc mounting part 164 may have a circular shape when being viewed from above such that the disc may be inserted thereinto.

Further, the disc mounting part 164 and the rotor hub 122 may form an insertion groove 168 therebetween in a central portion of the disc mounting part 164. That is, the insertion groove 168 may be formed to be indented downwardly from the disc mounting part 164 in the axial direction.

Further, the mounting part 162 may be formed to protrude upwardly from a central portion of the insertion groove 168 in the axial direction.

Meanwhile, the disc seating part 122c of the rotor hub 122 is inserted into the insertion groove 168 when the rotor hub 122 is coupled to the shaft 124. Therefore, the internal space may be formed by the rotor hub 122 and the insertion groove 168, and the stator core 146 may be disposed in the internal space formed by the rotor hub 122 and the insertion groove 168.

The cleaning solution penetration prevention part 180 may be mounted on at least one of the base member 160 and an opposite surface of the rotor hub 122 facing the base member 160.

In more detail, the cleaning solution penetration prevention part 180 maybe mounted on at least one of the disc seating part 122c inserted into the insertion groove 168 and an opposite surface of the base member 160 facing the disc seating part 122c.

Further, the cleaning solution penetration prevention part 180 may include an indented groove 182 formed in at least one of the disc seating part 122c and the opposite surface of the base member 160 facing the disc seating part 122c, and a cleansing solution blocking agent 184 filling the indented groove 182.

That is, the indented groove 182 may include a first indented groove 182a indented inwardly from the outer peripheral surface of the disc seating part 122c in the radial direction and a second indented groove 182b indented outwardly from a side wall 168a of the insertion groove 168 facing the outer peripheral surface of the disc seating part 122c in the radial direction.

However, the indented groove 182 in the present embodiment of the invention is formed in both of the outer peripheral surface of the disc seating part 122c and the side wall 168a of the insertion groove 168; however, the invention is not limited thereto. The indented groove 182 maybe formed in one of the disc seating part 122c and the side wall 168a of the insertion groove 168.

Further, the cleaning solution blocking agent 184 filling the indented groove 182 serves to prevent the cleaning solution from being introduced into the internal space formed by the rotor hub 122 and the insertion groove 168.

Meanwhile, the cleaning solution blocking agent 184 may be formed by dissolving a fluorine-based resin in a fluorine-based solvent. For example, the cleaning solution blocking agent 184 may be, for example, DURASURF 1100 series product produced by Harves Co., Ltd.

Here, the cleaning solution may be obtained by diluting a surfactant, alcohol (IPA), a chlorine-based material (HCFC, or the like), a hydrocarbon-based material (FRK 100, FRK 4) with water.

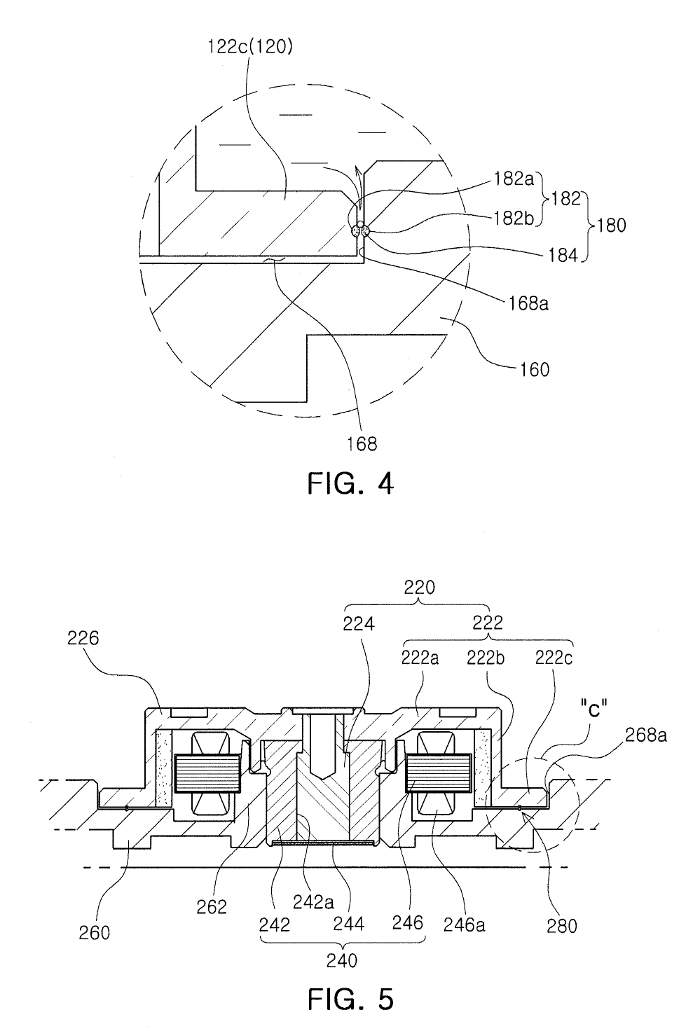

As shown in FIG. 4, the cleaning solution blocking agent 184 allows the cleaning solution to form a droplet having a predetermined size, thereby preventing the cleaning solution from passing through between the cleaning solution blocking agents 184.

That is, the cleaning solution introduced into the space between the disc seating part 122c and the side wall 168a of the insertion groove 168 forms a droplet having a predetermined size by the cleansing solution blocking agent 184 to prevent the droplet from moving downwardly of the cleaning solution blocking agent 184, whereby the introduction of the cleaning solution may be prevented.

In more detail, the introduced cleaning solution forms a droplet having a predetermined size by the cleaning solution blocking agent 184, but the size of the droplet is gradually increased, such that the droplet cannot pass between the cleaning solution blocking agents 184 until a surface tension having a predetermined force is generated. That is, the cleaning solution cannot pass through the cleaning solution blocking agents 184 since the size of the droplet cannot be increased in the space between the disc seating part 122c and the side wall 168a of the insertion groove 168.

Therefore, even when the base assembly 100 is dipped in the cleaning solution, the cleaning solution is not introduced into the internal space formed by the disc seating part 122c and the insertion groove 168 and thus, the base assembly 100 may be cleaned by being dipped in the cleaning solution.

As a result, foreign objects having a micro size remaining in the base assembly 100 maybe removed from the base assembly 100 by the cleaning solution.

Meanwhile, the cleaning solution blocking agent 184 in the present embodiment of the invention fills the indented groove 182. However, the cleaning solution blocking agent 184 may be applied to the outer peripheral surface of the disc seating part 122c and the side wall 168a of the insertion groove 168 as well as the indented groove 182.

As described above, the cleaning process of the base assembly 100 may be performed using the cleaning solution by preventing the cleaning solution from being introduced into the space formed by the rotor hub 122 and the base member 160 through the cleaning solution penetration prevention part 180.

That is, foreign objects having a micro size remaining in the base assembly 100 may be removed from the base assembly 100 by the cleaning process using the cleaning solution.

Hereinafter, a base assembly according to another embodiment of the present invention will be described with reference to the accompanying drawings. However, a detailed description of the same components as the above-mentioned components will be omitted and be replaced by the above-mentioned description.

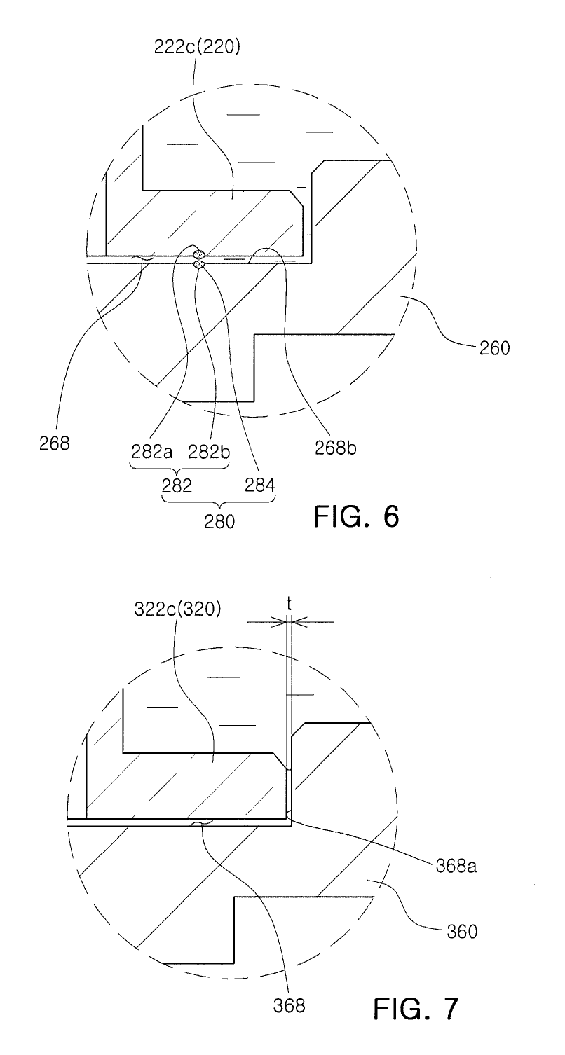

FIG. 5 is a schematic cross-sectional view showing a base assembly according to another embodiment of the present invention, and FIG. 6 is an enlarged view showing portion C of FIG. 5.

Referring to FIGS. 5 and 6, a base assembly 200 according to another embodiment of the present invention may include, for example, a rotor 220, a stator 240, a base member 260, and a cleaning solution penetration prevention part 280.

Meanwhile, the rotor 220, the stator 240, and the base member 260 of the base assembly 200 according to this embodiment of the present invention are substantially identical to the rotor 120, the stator 140, and the base member 160 of the base assembly 100 according to the previous embodiment of the present invention, and therefore, a detailed description thereof will be omitted.

The cleaning solution penetration prevention part 280 may be mounted on at least one of the base member 260 and an opposite surface of the rotor hub 222 facing the base member 260.

In more detail, the cleaning solution penetration prevention part 280 may be mounted on at least one of a disc seating part 222c inserted into an insertion groove 268 and an opposite surface of the base member 260 facing the disc seating part 222c.

Further, the cleaning solution penetration prevention part 280 may include an indented groove 282 formed in at least one of the disc seating part 222c and the opposite surface of the base member 260 facing the disc seating part 122c, and a cleansing solution blocking agent 284 filling the indented groove 282.

The indented groove 282 may include a first indented groove 282a indented upwardly from a bottom surface of the disc seating part 222c in the axial direction and a second indented groove 282b indented downwardly from a bottom surface 268b of the insertion groove 268 facing the bottom surface of the disc seating part 222c in the axial direction.

However, the indented groove 282 in the present embodiment of the invention is formed in both of the outer peripheral surface of the disc seating part 222c and the bottom surface 268b of the insertion groove 268; however, the invention is not limited thereto. The indented groove 282 may be formed in one of the disc seating part 122c and the bottom surface 268b of the insertion groove 268.

Further, the cleaning solution blocking agent 284 filling the indented groove 282 serves to prevent the cleaning solution from being introduced into the internal space formed by the rotor hub 222 and the insertion groove 268.

The cleaning solution blocking agent 284 serves to prevent the cleaning solution from passing through between the cleaning solution blocking agents 284 by allowing the cleaning solution to form a droplet having a predetermined size.

That is, the cleaning solution introduced into the space between the disc seating part 222c and the bottom surface 268b of the insertion groove 268 forms a droplet having a predetermined size by the cleansing solution blocking agents 284 to prevent the droplet from moving inwardly of the cleaning solution blocking agents 284 in the radial direction, whereby the introduction of the cleaning solution may be prevented.

In more detail, the introduced cleaning solution forms the droplet having a predetermined size by the cleaning solution blocking agent 284, but the size of the droplet is gradually increased, such that the droplet cannot pass between the cleaning solution blocking agents 284 until a surface tension having a predetermined force is generated. That is, the cleaning solution cannot pass through the cleaning solution blocking agent 284 since the size of the droplet cannot be increased in the space between the disc seating part 222c and the bottom surface 268b of the insertion groove 268.

Therefore, even when the base assembly 200 is dipped in the cleaning solution, the cleaning solution is not introduced into the internal space formed by the disc seating part 222c and the insertion groove 268 and thus, the base assembly 200 may be cleaned by being dipped in the cleaning solution.

As a result, foreign objects having a micro size remaining in the base assembly 200 may be removed from the base assembly 200 by the cleaning solution.

Hereinafter, a base assembly according to another embodiment of the present invention will be described with reference to the accompanying drawings. However, a detailed description of the same components as the above-mentioned components will be omitted and be replaced by the above-mentioned description.

FIG. 7 is an enlarged view showing a portion corresponding to portion B of FIG. 3 of a base assembly according to another embodiment of the present invention.

Referring to FIG. 7, a width t of a gap between a base member 360 and an opposite surface of a rotor hub 322 facing the base member 360 may be set to 0.3 mm or less.

In other words, the width t of the gap between the outer peripheral surface of the disc seating part 322c and a side wall 368a of an insertion groove 368 of the base member 360 may be set to 0.3 mm or less.

In this case, as shown in the following Table, the cleaning solution is not introduced into the internal space formed by the rotor hub 322 and the insertion groove 368.

TABLE 1

| | Penetration of |
|---|---|
| Width t of Gap(mm) | Cleaning Solution |
| 0.05 | x |
| 0.1 | x |
| 0.2 | x |
| 0.4 | x |
| 0.6 | x |
| 1.0 | ∘ |
| 2.0 | ∘ |

As described above, when the width t of the gap between the outer peripheral surface of the disc seating part 322c and the side wall 368a of the insertion groove 368 of the base member 360 is set to 0.6 mm or less, the cleaning solution is not introduced into the internal space formed by the rotor hub 322 and the insertion groove 368.

However, since the cleaning solution may pass through the gap between the outer peripheral surface of the disc seating part 322c and the side wall 368a of the insertion groove 368 of the base member 360 according to a depth of the cleaning solution contained in a cleaning solution tank, to thereby be introduced into the internal space, the width t of the gap may be preferably set to 0.3 mm or less in order to surely prevent the penetration of the cleaning solution.

As set forth above, according to embodiments of the present invention, cleaning may be easily performed using a cleaning solution by allowing a cleaning solution penetration prevention part to prevent the cleaning solution from being introduced into a space formed by a rotor hub and a base member.

Further, cleaning may be easily performed using the cleaning solution by forming a gap formed by the base member and the rotor hub to have a width of 0.3 mm or less to prevent the cleaning solution from being introduced into the space formed by the rotor hub and the base member.

While the present invention has been shown and described in connection with the embodiments, it will be apparent to those skilled in the art that modifications and variations can be made without departing from the spirit and scope of the invention as defined by the appended claims.

What is claimed is:

1. A base assembly, comprising:
a rotor including a rotor hub on which at least one disc is mounted;
a stator rotatably supporting the rotor; and
a base member having the stator fixedly mounted thereon and forming an internal space with the rotor hub,
wherein at least one of the base member and an opposite surface of the rotor hub facing the base member has a cleaning solution penetration prevention part.

2. The base assembly of claim 1, wherein the rotor hub includes:
a disc-shaped body;
a magnet mounting part extending downwardly from the body in an axial direction; and
a disc seating part extending from the magnet mounting part in a radial direction.

3. The base assembly of claim 2, wherein the base member is provided with an insertion groove to thereby form an internal space with the rotor hub, and
the cleaning solution penetration prevention part is disposed in at least one of the disc seating part inserted into the insertion groove and an opposite surface of the base member facing the disc seating part.

4. The base assembly of claim 2, wherein the cleaning solution penetration prevention part includes a cleaning solution blocking agent applied to at least one of the disc seating part and the opposite surface of the base member facing the disc seating part.

5. The base assembly of claim 4, wherein the cleaning solution penetration prevention part further includes an indented groove formed in at least one of the disc seating part and the opposite surface of the base member facing the disc seating part, and
the indented groove is filled with the cleaning solution blocking agent.

6. The base assembly of claim 5, wherein the indented groove is formed in at least one of an outer peripheral surface of the disc seating part and a side wall of the insertion groove facing the outer peripheral surface of the disc seating part.

7. The base assembly of claim 5, wherein the indented groove is formed in at least one of a bottom surface of the disc seating part and a bottom surface of the insertion groove facing the bottom surface of the disc seating part.

8. The base assembly of claim 4, wherein the cleaning solution blocking agent is formed by dissolving a fluorine-based resin in a fluorine-based solvent.

9. A base assembly, comprising:
a rotor including a rotor hub on which at least one disc is mounted;
a stator rotatably supporting the rotor; and
a base member having the stator fixedly mounted thereon and forming an internal space with the rotor hub,
wherein the base member and an opposite surface of the rotor hub facing the base member have a gap therebetween, the gap having a width of 0.3 mm or less.

10. The base assembly of claim 9, wherein the rotor hub includes:
a disc-shaped body;
a magnet mounting part extending downwardly from the body in an axial direction; and
a disc seating part extending from the magnet mounting part in a radial direction, and
an outer peripheral surface of the disc seating part and an opposite surface of the base member facing the outer peripheral surface of the disc seating part has a gap therebetween, the gap having a width of 0.3 mm or less.

11. The base assembly of claim 10, wherein the base member is provided with an insertion groove to thereby form an internal space with the rotor hub.
